(19) United States
(12) Patent Application Publication
(10) Pub. No.: US 2024/0378258 A1
(43) Pub. Date: Nov. 14, 2024

(54) INFORMATION PROCESSING APPARATUS, INFORMATION PROCESSING METHOD, INFORMATION PROCESSING SYSTEM, AND STORAGE MEDIUM

(71) Applicant: NEC Corporation, Minato-ku, Tokyo (JP)

(72) Inventor: Kei TAKEMURA, Tokyo (JP)

(73) Assignee: NEC Corporation, Minato-ku, Tokyo (JP)

(21) Appl. No.: 18/696,416

(22) PCT Filed: Oct. 12, 2021
(86) PCT No.: PCT/JP2021/037653

§ 371 Date: Mar. 28, 2024

(51) Int. Cl. G06F 17/11

(52) U.S. Cl. CPC G06F 17/11

(57) ABSTRACT

To prevent rewards that are obtained from becoming excessively low in a situation where selectable options can change every round, an information processing apparatus (1) includes: an acquisition section (11) that acquires information indicative of a set of options selectable in a round; a selection section (12) that selects a plurality of options from the set; and an accumulation section (13) that accumulates data including (i) the plurality of options selected by the selection section (12) and (ii) observed values of rewards obtained by the plurality of options selected by the selection section (12), the selection section (12) selecting the plurality of options such that a predicted value of a reward satisfies a constraint condition determined in accordance with a baseline option selected from the set, the predicted value being obtained with reference to the data which has been accumulated by the accumulation section (13).

### TECHNICAL FIELD

The present invention relates to an information processing apparatus, an information processing method, an information processing system, and a program all of which select an option.

### BACKGROUND ART

A technique is known which executes optimization of an index under a condition where a function representing the index to be optimized can change sequentially (also referred to as online optimization). Further, in the technique of online optimization, conservative optimization which ensures a certain level of accuracy (reward) by setting a baseline is known (for example, Non-Patent Literatures 1 to 3).

### CITATION LIST

### Non-Patent Literature

### Non-Patent Literature 1

Abbas Kazerouni et. al., ‘Conservative Contextual Linear Bandits’, Mar. 4, 2017

### Non-Patent Literature 2

Evrard Garcelon et. al., ‘Improved Algorithms for Conservative Exploration in Bandits’, Feb. 8, 2020

### Non-Patent Literature 3

Sumeet Katariya et. al., ‘Conservative Exploration using Interleaving’, Jun. 3, 2018

### SUMMARY OF INVENTION

### Technical Problem

In the techniques disclosed in Non-Patent Literatures 1 and 2, it is only possible to select a single option by a single decision-making. The techniques also have a problem that it is not possible to ensure the performance individually in each decision-making (each round). The technique disclosed in Non-Patent Literature 3 allows selection of a plurality of options in a single decision-making, but since the entire options (the population of options) are fixed, the technique cannot be applied to a situation where the population can change over time.

An example aspect of the present invention has been made in view of the above problem, and an example of the object thereof is to provide a technique that makes it possible to prevent rewards that are obtained from becoming excessively low in a situation where selectable options can change every round.

### Solution to Problem

An information processing apparatus in accordance with an example aspect of the present invention is an information processing apparatus, including: an acquisition means for acquiring information indicative of a set of options that are selectable in a round; a selection means for selecting a plurality of options from the set; and an accumulation means for accumulating data that includes (i) the plurality of options which have been selected by the selection means and (ii) observed values of rewards obtained by the plurality of options which have been selected by the selection means, the selection means selecting the plurality of options such that a predicted value of a reward satisfies a constraint condition determined in accordance with a baseline option selected from the set, the predicted value being obtained with reference to the data which has been accumulated by the accumulation means.

An information processing method in accordance with an example aspect of the present invention is an information processing method, including, in a repeated manner, the steps of: an information processing apparatus acquiring information indicative of a set of options that are selectable in a round; the information processing apparatus selecting a plurality of options from the set; and the information processing apparatus accumulating data that includes (i) the plurality of options which have been selected in the step of selecting the plurality of options and (ii) observed values of rewards obtained by the plurality of options which have been selected in the step of selecting the plurality of options, wherein, in the step of selecting the plurality of options, the plurality of options are selected such that a predicted value of a reward satisfies a constraint condition determined in accordance with a baseline option selected from the set, the predicted value being obtained with reference to the data which has been accumulated.

A program in accordance with an example aspect of the present invention is a program causing a computer to function as an information processing apparatus, wherein the program causes the computer to function as: an acquisition means for acquiring information indicative of a set of options that are selectable in a round; a selection means for selecting a plurality of options from the set; and an accumulation means for accumulating data that includes (i) the plurality of options which have been selected by the selection means and (ii) observed values of rewards obtained by the plurality of options which have been selected by the selection means, the selection means selecting the plurality of options such that a predicted value of a reward satisfies a constraint condition determined in accordance with a baseline option selected from the set, the predicted value being obtained with reference to the data which has been accumulated by the accumulation means.

An information processing system in accordance with an example aspect of the present invention is an information processing system, including an information processing apparatus and a terminal apparatus, wherein the information processing apparatus includes: an acquisition means for acquiring information indicative of a set of options that are selectable in a round; a selection means for selecting a plurality of options from the set; and an accumulation means for accumulating data that includes (i) the plurality of options which have been selected by the selection means and (ii) observed values of rewards obtained by the plurality of options which have been selected by the selection means, the selection means selecting the plurality of options such that a predicted value of a reward satisfies a constraint condition determined in accordance with a baseline option selected from the set, the predicted value being obtained with reference to the data which has been accumulated by the accumulation means, and the terminal apparatus includes: an option acquisition means for acquiring the plurality of options which have been selected by the selection means; and a reward information provision means for providing, to the information processing apparatus, reward information indicative of rewards obtained by executing actions indicated by the plurality of options.

An information processing method in accordance with an example aspect of the present invention is an information processing method, including, in a repeated manner, the steps of: an information processing apparatus acquiring information indicative of a set of options that are selectable in a round; the information processing apparatus selecting a plurality of options from the set; and the information processing apparatus accumulating data that includes (i) the plurality of options which have been selected in the step of selecting the plurality of options and (ii) observed values of rewards obtained by the plurality of options which have been selected in the step of selecting the plurality of options, wherein, in the step of selecting the plurality of options, the plurality of options are selected such that a predicted value of a reward is increased under a constraint condition determined in accordance with a baseline option selected from the set, the predicted value being obtained with reference to the data which has been accumulated, the information processing method further including the steps of: a terminal apparatus acquiring the plurality of options which have been selected in the step of selecting the plurality of options; and the terminal apparatus providing, to the information processing apparatus, reward information indicative of rewards obtained by executing actions indicated by the plurality of options.

### Advantageous Effects of Invention

According to an example aspect of the present invention, it is possible to prevent rewards that are obtained from becoming excessively low in a situation where selectable options can change every round.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method carried out by the information processing apparatus in accordance with the first example embodiment of the present invention.

FIG. 3 is a block diagram illustrating a configuration of an information processing system in accordance with the first example embodiment of the present invention.

FIG. 4 is a flowchart illustrating a flow of an information processing method carried out by the information processing system in accordance with the first example embodiment of the present invention.

FIG. 5 is a block diagram illustrating a configuration of an information processing system in accordance with a second example embodiment of the present invention.

FIG. 6 is a flowchart illustrating a flow of an information processing method carried out by an information processing apparatus in accordance with the second example embodiment of the present invention.

FIG. 7 is a view illustrating an example screen in accordance with the second example embodiment of the present invention.

FIG. 8 is a block diagram illustrating a configuration of an information processing apparatus in accordance with a third example embodiment of the present invention.

FIG. 9 is a block diagram illustrating an example of a hardware configuration of the information processing apparatus in each of the example embodiments of the present invention.

### EXAMPLE EMBODIMENTS

### First Example Embodiment

A first example embodiment of the present invention will be described in detail with reference to the drawings. The present example embodiment is a basic form of an example embodiment described later.

### <Outline of Information Processing Apparatus>

The information processing apparatus 1 is an apparatus which selects a plurality of options from a set of options selectable in a round t (1≤t≤T; t and T are each a natural number). In selection of options, the information processing apparatus 1 selects the options such that a predicted value(s) of a reward(s) in a round t satisfies/satisfy a constraint condition.

### (Options and Reward)

A specific example of an option is not intended to limit the present example embodiment. For example, an option is content recommended on a web page, a price of a product, or a purchase amount of a product. An option is represented, for example, as a d-dimensional feature vector (d is a natural number of 1 or more). A specific example of a reward is not intended to limit the present example embodiment. For example, a reward is: whether or not a user selects (by clicking or the like) content that is an option; sales of a product; an inverse of an inventory level of a product; or a value obtained by subtracting an inventory level of a product from a constant”.

### <Configuration of Information Processing Apparatus>

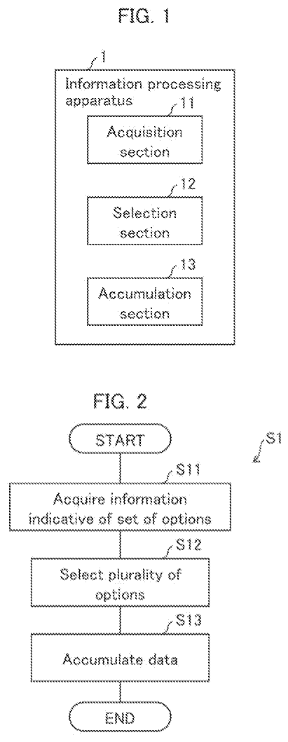

FIG. 1 is a block diagram illustrating a configuration of the information processing apparatus 1. As illustrated in FIG. 1, the information processing apparatus 1 includes an acquisition section 11, a selection section 12, and an accumulation section 13. The acquisition section 11 is configured to realize an acquisition means in the present example embodiment. The selection section 12 is configured to realize a selection means in the present example embodiment. The accumulation section 13 is configured to realize an accumulation means in the present example embodiment.

### (Acquisition Section)

The acquisition section 11 acquires information indicative of a set {xₜ(i)} of options that are selectable in a round t. Note that i [N] where N is the number of options selectable in the round t. [N] is a set of natural numbers from 1 to N. The set {xₜ(i)} can change from round t to round t. For example, in a case where options are contents recommended on a web page, selectable options (i.e., contents that are recommended) may be added or deleted over rounds t. Each element (option) included in the set {xₜ(i)} is a candidate for the plurality of options to be selected by the selection section 12.

### (Selection Section and Accumulation Section)

The selection section 12 selects a plurality of options from the set {xₜ(i)}. The accumulation section 13 accumulates data including: the plurality of options which have been selected by the selection section 12; and observed values of rewards obtained by the plurality of options which have been selected by the selection section 12. The selection section 12 selects the plurality of options such that a predicted value(s) of a reward(s) satisfies/satisfy a constraint condition determined in accordance with a baseline option(s) Iₜ^{b} selected from the set {xₜ(i)}, the predicted value(s) being obtained with reference to the data which has been accumulated by the accumulation section 13. Hereinafter, a set of options selected by the selection section 12 in a round t is also referred to as “options Iₜ”. The options Iₜ are a subset of the set {xₜ(i)}.

### (Predicted Value of Reward)

The predicted value(s) of a reward(s) in the round t is/are a value(s) obtained with reference to data which has been accumulated by the accumulation section 13, i.e., at least part of options Iₜ and observed values of rewards in each of rounds 1 to (t−1). The predicted value(s) of a reward(s) for an option(s) I in the round t, which option(s) I is/are a candidate(s) for the options Iₜ, is, for example, a sum of predicted values of rewards calculated for the respective options included in the options I. The option(s) I is/are a candidate(s) for the options Iₜ to be selected by the selection section 12, and is/are a subset of the set {xₜ(i)}.

### (Baseline Option)

The baseline option(s) Iₜ^{b} is/are a set of an option(s) selected from the set {xₜ(i)} (i.e., a subset of the set {xₜ(i)}) and is/are a set of option(s) for which a certain level of reward is ensured in the round t. A level of reward obtained by the baseline option(s) Iₜ^{b} does not have to be maximum, and can be any level that is not excessively low. A method of selecting the baseline option(s) Iₜ^{b} is not limited, and can be, for example, a rule-based selection method or a selection method that uses a prediction model generated by machine learning. A specific example of the baseline option(s) Iₜ^{b} is not intended to limit the present example embodiment. For example, a baseline option Iₜ^{b} is content having a predetermined attribute (e.g. book content) among contents recommended on a web page, a fixed price of a product, or an average value of a purchase amount.

In the case of rule-based selection, the baseline option(s) Iₜ^{b} is/are, for example, a set of an option(s) each having a predetermined attribute among the set {xₜ(i)}. Note that the rule-based selection method is not limited to the above example, and can be other selection methods. In the case of selection using a prediction model, the baseline option(s) Iₜ^{b} is/are selected, for example, with use of a prediction model that receives input of options xₜ(i) and outputs predicted values rₜ(i) of rewards obtained by the options xₜ(i). Note that input and output to and from the prediction model is not limited to the above example, and can be any input and output provided that the output can be used for selection of the baseline option(s) Iₜ^{b}. A method of machine learning of the prediction model is not limited. For example, a decision tree-based method, a linear regression method, or a neural network method may be used, or two or more of these methods may be used. Examples of the decision tree-based method include Light gradient boosting machine (LightGBM), random forest, and XGBoost. Examples of the linear regression method include support vector regression, ridge regression, lasso regression, and ElasticNet. Examples of the neural network method include deep learning.

### (Constraint Condition)

A constraint condition is a condition which prescribes a constraint on a predicted value(s) of a reward(s). The constraint condition is a condition which is determined in accordance with the baseline option(s) Iₜ^{b}. For example, the constraint condition is expressed by expression (1) below.

$$\sum \text{?} E [ {r}_{t} ( i ) ] \geq ( 1 - α ) \sum \text{?} E [ {r}_{t} ( i ) ] \qquad ( 1 )$$

$$\text{?} \text{indicates text missing or illegible when filed}$$

In expression (1), predicted values rₜ(i) are predicted values of rewards obtained by options i in a round t. The parameter α is a real number that satisfies α [0, 1], that is, a real number that is not less than 0 and not more than 1. E is a symbol of operation of an expected value.

More specifically, the constraint condition is, for example, expressed for each round t with use of at least (i) a sum of an upper confidence bound(s) of a reward(s) obtained by a baseline option(s) Iₜ^{b} in each round t and (ii) a sum of a lower confidence bound(s) of a reward(s) obtained by at least part of a set I of options that are candidates for options Iₜ in each round t. In this case, the constraint condition is expressed by, for example, expression (2) below.

$$\sum \text{?} {\hat{r}}_{t} ( i ) + \sum \text{?} ( α {\hat{r}}_{t} ( i ) + ( 1 - α ) {\hat{r}}_{t} ( i ) ) \geq ( 1 - α ) \sum \text{?} {\hat{r}}_{t} ( i ) \\ In expression ( 2 ) , \\ {\hat{r}}_{t} ( i ) \qquad ( 2 )$$

$$\text{?} \text{indicates text missing or illegible when filed}$$

is an upper confidence bound of a reward by an option i I in the round t, and
\hat{r}ₜ(i)
is a lower confidence bound of a reward by an option i I in the round t. In expression (2) above, in a case where the set I of options is baseline options Iₜ^{b}, a predicted value(s) of a reward(s) satisfies/satisfy the constraint condition expressed by expression (2) above. As such, the constraint condition expressed by expression (2) above is never “without a solution”.

The constraint condition is not limited to the above-described example, and can be any constraint condition that is determined in accordance with the baseline option(s) Iₜ^{b}.

### <Effect of Information Processing Apparatus>

According to the information processing apparatus 1 in accordance with the present example embodiment, information indicative of a set {xₜ(i)} of options selectable in a round t is acquired, a plurality of options are selected from the acquired set {xₜ(i)}, and data is accumulated, the data including: the plurality of options which have been selected; and observed values of rewards obtained by the plurality of options which have been selected. Further, in selection of options, the information processing apparatus 1 selects a plurality of options such that a predicted value(s) of a reward(s) satisfies/satisfy a constraint condition determined in accordance with a baseline option(s) Iₜ^{b} selected from the set {xₜ(i)}, the predicted value(s) being obtained with reference to data which has been accumulated. As such, according to the information processing apparatus 1 in accordance with the present example embodiment, it is possible to prevent rewards from becoming excessively low in a situation where selectable options can change from round to round.

### <Flow of Information Processing Method>

A flow of an information processing method S1 carried out by the information processing apparatus 1 configured as described above will be described with reference to FIG. 2. FIG. 2 is a flowchart illustrating the flow of the information processing method S1. The information processing apparatus 1 repeatedly carries out selection of options by repeating the information processing method S1. Note that description of matters already described will be omitted here. As illustrated in FIG. 2, the information processing method S1 includes steps S11 to S13.

### (Step S11)

In step S11, the acquisition section 11 acquires information indicative of a set {xₜ(i)} of options that are selectable in a round t. For example, the acquisition section 11 can acquire the information indicative of the set {xₜ(i)} by receiving the information via a communication interface of the information processing apparatus 1, or can acquire the information indicative of the set {xₜ(i)} via an input interface of the information processing apparatus 1. Alternatively, the acquisition section 11 can acquire the information indicative of the set {xₜ(i)} by reading out the information from a storage apparatus.

### (Step S12)

In step S12, the selection section 12 selects a plurality of options from the set {xₜ(i)}. In step S12 (step of selecting a plurality of options), the selection section 12 selects the plurality of options such that a predicted value(s) of a reward(s) satisfies/satisfy a constraint condition determined in accordance with a baseline option(s) Iₜ^{b} selected from the set {xₜ(i)}, the predicted value(s) being obtained with reference to data which has been accumulated.

### (Step S13)

In step S13, the accumulation section 13 accumulates data including: the plurality of options selected in step S12 (step of selecting a plurality of options); and observed values of rewards obtained by the plurality of options selected in step S12 (step of selecting a plurality of options).

### <Effect of Information Processing Method>

According to the information processing method S1 in accordance with the present example embodiment, the information processing apparatus 1 acquires information indicative of a set {xₜ(i)} of options selectable in a round t, selects a plurality of options from the acquired set {xₜ(i)}, and accumulates data including: the plurality of options which have been selected; and observed values of rewards obtained by the plurality of options which have been selected. Further, in the step of selecting options Iₜ in the information processing method S1, the plurality of options are selected such that a predicted value(s) of a reward(s) satisfy a constraint condition determined in accordance with a baseline option(s) Iₜ^{b} selected from the set {xₜ(i)}, the predicted value(s) being obtained with reference to data which has been accumulated. As such, according to the information processing method S1 in accordance with the present example embodiment, it is possible to prevent rewards from becoming excessively low in a situation where selectable options can change every round.

### <Configuration of Information Processing System>

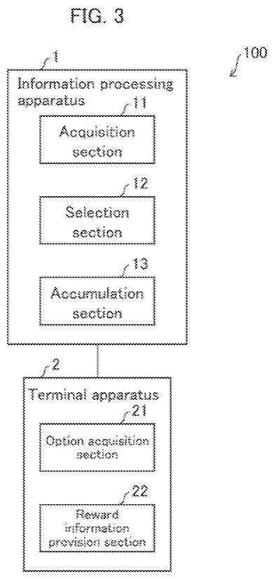

Next, a configuration of an information processing system 100 in accordance with the present example embodiment will be described with reference to FIG. 3. FIG. 3 is a block diagram illustrating the configuration of the information processing system 100. As illustrated in FIG. 3, the information processing system 100 includes the information processing apparatus 1 and a terminal apparatus 2. Since the components included in the information processing apparatus 1 have already been described, descriptions of the components will not be repeated here.

The terminal apparatus 2, as illustrated in FIG. 3, includes an option acquisition section 21 and a reward information provision section 22. The option acquisition section 21 is configured to realize an option acquisition means in the present example embodiment. The reward information provision section 22 is configured to realize a reward information provision means in the present example embodiment.

The option acquisition section 21 acquires a plurality of options selected by the selection section 12. The reward information provision section 22 provides, to the information processing apparatus 1, reward information indicative of rewards obtained by executing actions indicated by the plurality of options which have been acquired by the option acquisition section 21.

### <Effect of Information Processing System>

According to the information processing system 100 in accordance with the present example embodiment, information indicative of a set {xₜ(i)} of options selectable in a round t is acquired, a plurality of options are selected from the acquired set {xₜ(i)}, and data is accumulated, the data including: the plurality of options which have been selected; and observed values of rewards obtained by the plurality of options which have been selected. Further, in the step of selecting options Iₜ, the information processing system 100 selects a plurality of options such that a predicted value(s) of a reward(s) satisfies/satisfy a constraint condition determined in accordance with a baseline option(s) Iₜ^{b} selected from the set {xₜ(i)}, the predicted value(s) being obtained with reference to data which has been accumulated. As such, according to the information processing apparatus 100 in accordance with the present example embodiment, it is possible to prevent rewards that are obtained from becoming excessively low in a situation where selectable options can change every round.

### <Flow of Information Processing Method>

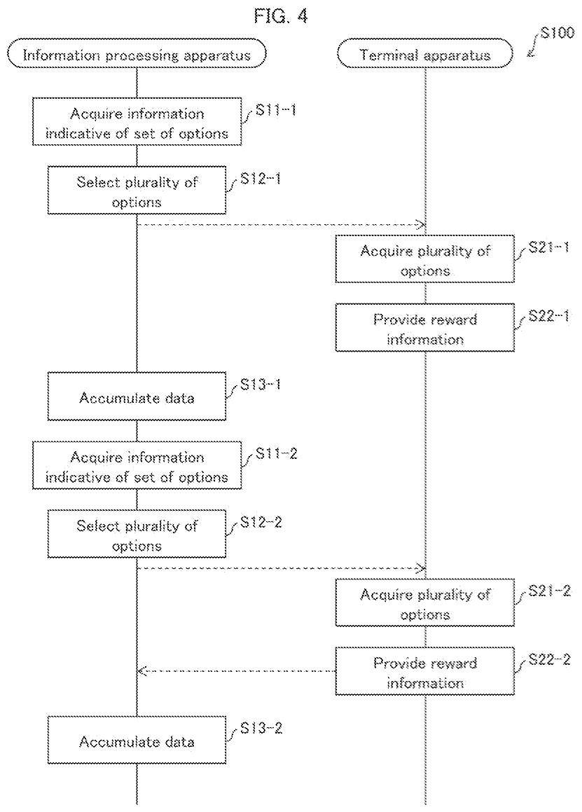

A flow of an information processing method S100 carried out by the information processing system 100 configured as described above will be described with reference to FIG. 4. FIG. 4 is a flowchart illustrating the flow of the information processing method S100. The information processing system 100 repeatedly carries out selection of options Iₜ by carrying out the information processing method S100. Note that description of matters already described will be omitted here.

As illustrated in FIG. 4, the information processing method S100 includes steps S11 to S13 and steps S21 and S22 in a repeated manner. Here, with respect to a numeral given to each step in FIG. 4, the order of the iteration is provided as a branch number followed by a hyphen “-”. For example, S21-1 indicates a first iteration, and S21-2 indicates a second iteration. The same applies to the other steps.

### (Step S11-1)

In step S11-1, the acquisition section 11 acquires information indicative of a set {xₜ(i)} of options that are selectable in a round t.

### (Step S12-1)

In step S12-1, the selection section 12 selects a plurality of options from the set {xₜ(i)}. In so doing, the selection section 12 selects, in step S12-1 (step of selecting a plurality of options), the plurality of options such that a predicted value(s) of a reward(s) are increased under a constraint condition determined in accordance with a baseline option(s) selected from the set {xₜ(i)}, the predicted value(s) being obtained with reference to data which has been accumulated.

### (Step S21-1)

In step S21-1, the option acquisition section 21 acquires the plurality of options selected in step S12-1 (step of selecting a plurality of options). For example, the option acquisition section 21 acquires the plurality of options via a communication interface or an input interface of the terminal apparatus 2.

### (Step S22-1)

In step S22-1, the reward information provision section 22 provides, to the information processing apparatus 1, reward information indicative of rewards obtained by executing actions indicated by the plurality of options. The reward information provision section 22 provides the reward information, for example, by transmitting the reward information via the communication interface or the input interface of the terminal apparatus 2.

### (Step S13-1)

In step S13-1, the accumulation section 13 accumulates data including: the plurality of options selected in step S12-1 (step of selecting a plurality of options); and observed values of rewards obtained by the plurality of options selected in step S12-1 (step of selecting a plurality of options).

### <Effect of Information Processing Method>

According to the information processing method S100 in accordance with the present example embodiment, information indicative of a set {xₜ(i)} of options selectable in a round t is acquired, a plurality of options are selected from the acquired set {xₜ(i)}, and data is accumulated, the data including: the plurality of options which have been selected; and observed values of rewards obtained by the plurality of options which have been selected. Further, in the step of selecting a plurality of options, the information processing apparatus 1 selects a plurality of options such that a predicted value(s) of a reward(s) satisfy a constraint condition determined in accordance with a baseline option(s) Iₜ^{b} selected from the set {xₜ(i)}, the predicted value(s) being obtained with reference to data which has been accumulated. As such, according to the information processing method S100 in accordance with the present example embodiment, it is possible to prevent rewards that are obtained from becoming excessively low in a situation where selectable options can change every round.

### Second Example Embodiment

The following will discuss in detail a second example embodiment of the present invention, with reference to drawings. Note that any constituent element that is identical in function to a constituent element described in the first example embodiment will be given the same reference numeral, and a description thereof will not be repeated.

### <Configuration of Information Processing System 100A>

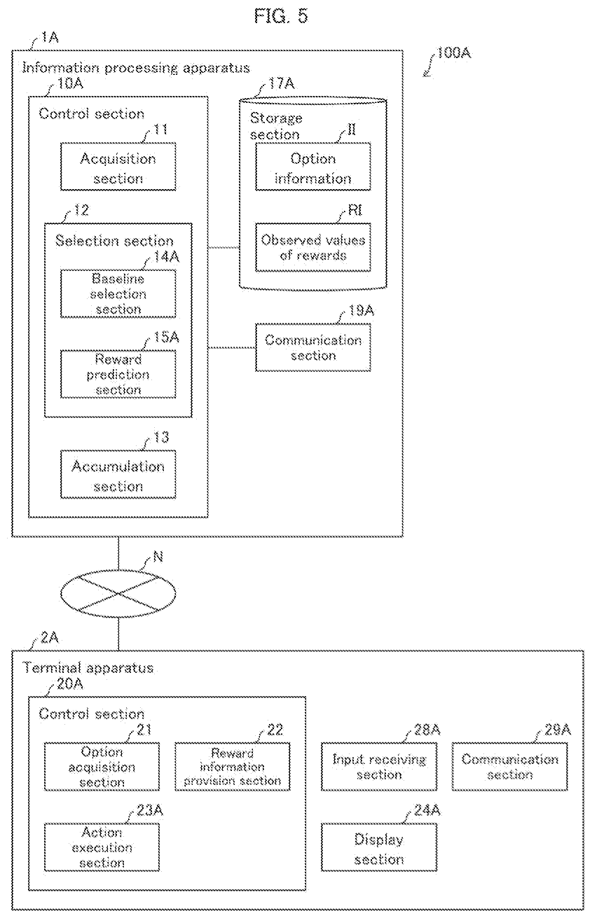

A configuration of an information processing system 100A in accordance with the present example embodiment will be described with reference to FIG. 5. FIG. 5 is a block diagram illustrating the configuration of the information processing system 100A. As illustrated in FIG. 5, the information processing system 100A includes an information processing apparatus 1A and a terminal apparatus 2A. In addition, as illustrated in FIG. 5, the information processing apparatus 1A and the terminal apparatus 2A are configured to be communicable with each other via a network N. Here, a specific configuration of the network N is not intended to limit the present example embodiment. As an example, it is possible to employ a wireless local area network (LAN), a wired LAN, a wide area network (WAN), a public network, a mobile data communication network, or a combination of these networks.

### <Configuration of Information Processing Apparatus 1A>

A configuration of an information processing apparatus 1A in accordance with the present example embodiment will be described with reference to FIG. 5. FIG. 5 is a block diagram illustrating the configuration of the information processing apparatus 1A. As illustrated in FIG. 5, the information processing apparatus 1A includes a control section 10A, a storage section 17A, and a communication section 19A. The communication section 19A communicates with an apparatus outside the information processing apparatus 1A. As an example, the communication section 19A communicates with the terminal apparatus 2A. The communication section 19A transmits, to the terminal apparatus 2A, data supplied from the control section 10A and supplies, to the control section 10A, data received from the terminal apparatus 2A.

### (Control Section 10A)

The control section 10A, as illustrated in FIG. 5, includes an acquisition section 11, a selection section 12, an accumulation section 13, a baseline selection section 14A, and a reward prediction section 15A. The acquisition section 11 is configured to realize an acquisition means in the present example embodiment. The selection section 12 is configured to realize a selection means in the present example embodiment. The accumulation section 13 is configured to realize an accumulation means in the present example embodiment. The baseline selection section 14A is configured to realize a baseline selection means in the present example embodiment. The reward prediction section 15A is configured to realize a reward prediction means in the present example embodiment.

The acquisition section 11 acquires information indicative of a set {xₜ(i)} of options that are selectable in a round t, as in the first example embodiment. A specific example of an option is not intended to limit the present example embodiment. For example, an option is content recommended on a web page, a price of a product, or a purchase amount of a product as in the first example embodiment.

The selection section 12 selects a plurality of options from the set {xₜ(i)} as in the first example embodiment. The selection section 12 selects the plurality of options such that a predicted value(s) of a reward(s) satisfies/satisfy a constraint condition determined in accordance with a baseline option(s) Iₜ^{b} selected from the set {xₜ(i)}, the predicted value(s) being obtained with reference to data which has been accumulated by the accumulation section 13. A specific example of a reward is not intended to limit the present example embodiment. For example, a reward is: whether or not a user selects (by clicking or the like) content that is an option; sales of a product; an inverse of an inventory level of a product; or a value obtained by subtracting an inventory level of a product from a constant.

The accumulation section 13 accumulates, as in the first example embodiment, data which includes: the plurality of options which have been selected by the selection section 12; and observed values of rewards obtained by the plurality of options which have been selected by the selection section 12.

The baseline selection section 14A selects the baseline option(s) Iₜ^{b} from the set {xₜ(i)}. The baseline selection section 14A can select the baseline option(s) Iₜ^{b}, for example, by rule-based selection or by selection with use of a prediction model generated by machine learning.

The reward prediction section 15A calculates the predicted value(s) of a reward(s) with reference to the data which has been accumulated by the accumulation section 13. A predicted value of a reward by an option i I includes, for example, at least one selected from the group consisting of: an upper confidence bound of a reward by the option i I; and a lower confidence bound of a reward by an option i I.

The storage section 17A stores various data to be referred to by the control section 10A. As an example, the storage section 17A, as illustrated in FIG. 5, stores option information II and observed values RI of rewards. The various data stored in the storage section 17A will be described later with reference to a different drawing.

### <Configuration of Terminal Apparatus 2A>

The terminal apparatus 2A, as illustrated in FIG. 5, includes a control section 20A, a display section 24A, an input receiving section 28A, and a communication section 29A. As an example, the terminal apparatus 2A can be concretely realized as a user terminal used by an end user who views a web page or the like, an accounting terminal located in a store, an inventory management terminal located in a warehouse, and the like. However, this is not intended to limit the present example embodiment.

The communication section 29A communicates with an apparatus outside the terminal apparatus 2A. As an example, the communication section 29A communicates with the information processing apparatus 1A. The communication section 29A transmits, to the information processing apparatus 1A, data supplied from the control section 20A and supplies, to the control section 20A, data received from the information processing apparatus 1A. The display section 24A displays various information under the control of the control section 20A. As an example, the display section 24A includes a display panel and a drive circuit for driving the display panel.

The control section 20A, as illustrated in FIG. 5, includes an option acquisition section 21, a reward information provision section 22, and an action execution section 23A. The option acquisition section 21 acquires a plurality of options which have been selected by the selection section 12 as in the first example embodiment. The reward information provision section 22 provides, to the information processing apparatus 1, reward information indicative of rewards obtained by executing actions indicated by the plurality of options.

The action execution section 23A executes actions based on the plurality of options which have been selected by the information processing apparatus 1. As an example, in a case where options which have been selected by the information processing apparatus 1 are a “product P1”, a “product P2”, and a “product P3”, the action execution section 23A displays, on the display section 24A, information recommending the “product P1”, the “product P2”, and the “product P3” on a web page. Further, as an example, in a case where an option which has been selected by the information processing apparatus 1 is “setting a price of a product to be a certain value”, the action execution section 23A sets a price associated with the product to be such a value. Further, as an example, in a case where an action which has been selected by the information processing apparatus 1 is “setting a purchase amount of a product to be a certain value”, the action execution section 23A sets a purchase amount associated with the product to be such a value.

The input receiving section 28A receives various inputs to the terminal apparatus 2A. A specific configuration of the input receiving section 28A is not intended to limit the present example embodiment. As an example, the input receiving section 28A includes an input device such as a keyboard and a touchpad. In addition, the input receiving section 28A may include, for example, a data scanner for reading data via electromagnetic waves, such as infrared rays and radio waves. The input receiving section 28A acquires various pieces of information via, for example, the input device, the data scanner, and the like, which are described above, and supplies the acquired pieces of information to the control section 20A. Here, the information acquired by the input receiving section 28A can include an observed value of a reward such as: information indicating that a clicking operation by the user with respect to content; or “sales” and “information related to an inventory level” on a product. In other words, the input receiving section 28A is an input device for receiving an observed value of a reward.

### (Examples of Data Stored in Storage Section)

As illustrated in FIG. 5, the storage section 17A stores option information II and observed values RI of rewards. The option information II is information indicative of options Iₜ selected by the selection section 12 in a round t. The observed values RI of rewards include observed values of rewards obtained by options Iₜ selected by the selection section 12 in a round t. The observed values RI of rewards are, as an example, acquired by the acquisition section 11 and stored in the storage section 17A. The observed values are, as an example, numerical values each of which indicates whether or not a user has selected recommended content. For example, in a case where the user does not select content in a round t, an observed value rₜ(i) for an option i Iₜ corresponding to the content is “0”. In a case where the user selects content in a round t, an observed value rₜ(i) for an option i Iₜ corresponding to the content is “1”. Note that the observed value rₜ(i) is not limited to the examples above, and can be other values. As an example, the observed value rₜ(i) can be a numerical value indicative of: sales of a product; an inverse of an inventory level of a product; a value obtained by subtracting an inventory level of a product from a constant; or the like.

### <Flow of Information Processing Method Carried Out by Information Processing Apparatus>

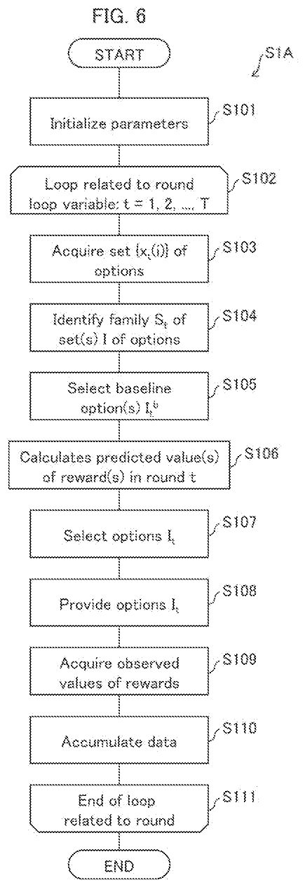

A flow of an information processing method S1A carried out by the information processing apparatus 1A configured as described above will be described with reference to FIG. 6. FIG. 6 is a flowchart illustrating the flow of the information processing method S1A. The information processing apparatus 1A carries out the information processing method S1A to thereby select options Iₜ such that a predicted value(s) of a reward(s) in a round t satisfies/satisfy a constraint condition. Rounds t, for example, represent the number of times content is inferred on a web page. Further, in the present operation example, an observed value rₜ(i) of a reward satisfies rₜ(i) [0, 1].

In the information processing method S1A illustrated in FIG. 6, the information processing apparatus 1A carries out computation with use of options xₜ(i), a matrix Vₜ, a vector bₜ, a parameter A, and a parameter β. Each option xₜ(i) is a d-dimensional feature vector (d is a natural number of 1 or more). The matrix Vₜ is a d×d matrix. The vector bₜ is a d-dimensional vector. The parameters λ and β are expressed, for example, by expression (3) below.

$$\begin{matrix}λ = d \\ β = \sqrt{d}\end{matrix} \qquad ( 3 )$$

### (Step S101)

In step S101, the selection section 12 performs initialization of various parameters. As an example, the selection section 12 sets a matrix V₀ to λI and sets a vector b₀ to a null vector as indicated by expression (4). Note that I represents a unit matrix in expression (4).

$$\begin{matrix}{V}_{0} ← λ I \\ {b}_{0} ← 0\end{matrix} \qquad ( 4 )$$

### (Step S102)

Step S102 is a start of a loop process which is related to a round t. Here, a loop variable in the round-related loop process is as follows:

$$t = 1 , 2 , … , T$$

### (Step S103)

In step S103 in the loop, the acquisition section 11 acquires, for each round t, information indicative of a set {xₜ(i)} of options xₜ(i) that are selectable. For example, the acquisition section 11 can acquire the information indicative of the set {xₜ(i)} from another apparatus (e.g. a predetermined cloud server) via the communication section 19A, or can acquire the information indicative of the set {xₜ(i)} by reading out the information from the storage section 17A.

### (Step S104)

Subsequently, in step S104 in the loop, the acquisition section 11 identifies a family Sₜ of a set(s) I of options which set(s) is/are a candidate(s) for options Iₜ to be selected by the selection section 12 in the round t. For example, in a case where the information processing system 100A is a system that recommends content on a web page and that recommends three options from among 10 options, the acquisition section 11 identifies a family Sₜ of a set(s) I of options which set(s) is/are a candidate(s) for options Iₜ, i.e., a family Sₜ of a set(s) I of options each of which set(s) is indicative of a combination of three options xₜ(i) included in the set {xₜ(i)}.

### (Step S105)

In step S105, the baseline selection section 14A selects a baseline option(s) Iₜ^{b} from the set {xₜ(i)}. The baseline selection section 14A can, for example, select the baseline option(s) Iₜ^{b} by rule-based selection or by selection with use of a prediction model generated by machine learning.

In a case of selecting the baseline option(s) Iₜ^{b} by rule-based selection, the baseline selection section 14A, for example, selects, as the baseline option(s) Iₜ^{b} from among a plurality of sets I of options, a set(s) of options which set(s) satisfies/satisfy a predetermined condition. The predetermined condition is, for example, a condition that part or all of the options included in a set I of options has/have a predetermined attribute. The predetermined attribute is, for example, an attribute corresponding to an end user who uses a web service. More specifically, for example, the baseline selection section 14A can select, as the baseline option(s) Iₜ^{b} from among a set {xₜ(i)} of options representing contents recommended to an end user, a set(s) I of options each of which set(s) include(s), at a ratio of not less than a threshold, options each recommending book content.

Further, the baseline selection section 14A can select the baseline option(s) Iₜ^{b}, for example, by selection with use of a prediction model constructed by machine learning. In this case, an input to the prediction model, for example, includes options xₜ(i), and an output from the prediction model, for example, includes predicted values rₜ(i) of rewards obtained by the options xₜ(i). In this case, the baseline selection section 14A, for example, scores the options xₜ(i) on the basis of the predicted values rₜ(i) of rewards obtained by inputting the options xₜ(i) to the prediction model, and selects the baseline option(s) Iₜ^{b} such that a sum of the scores is maximized. Note that the method of selecting the baseline option(s) Iₜ^{b} is not limited to the above example, and the baseline selection section 14A can select the baseline option(s) Iₜ^{b} by other methods.

### (Step S106)

In step S106, the reward prediction section 15A calculates a predicted value(s) of a reward(s) in the round t with reference to data which has been accumulated by the accumulation section 13. For example, the reward prediction section 15A calculates, as the predicted value(s) of a reward(s), an upper confidence bound(s) and a lower confidence bound(s) of an option(s) in the round t. In this case, the reward prediction section 15A, for example, calculates an upper confidence bound(s) in the round t by expression (5) below and calculates a lower confidence bound(s) in the round by expression (6) below.

$${\hat{r}}_{t} ( i ) ← min \{ {{\hat{θ}}_{t}}^{T} {x}_{t} ( i ) + {c}_{t} ( i ) , 1 \} for all i ∈ [ N ] \qquad ( 5 )$$

$${\hat{r}}_{t} ( i ) ← max \{ {{\hat{θ}}_{t}}^{T} {x}_{t} ( i ) - {c}_{t} ( i ) , 0 \} for all i ∈ [ N ] \qquad ( 6 )$$

In expression (5) and expression (6),

\hat{θ}ₜ
is a matrix expressing linear contribution of options to rewards, and
cₜ(i)
is a vector expressing nonlinear contribution of options to rewards. These are calculated, for example, by expression (7) and expression (8), respectively.

$${\hat{θ}}_{t} ← {V}_{t - 1}^{- 1} {b}_{t - 1} \qquad ( 7 )$$

$${c}_{t} ( i ) ← β \sqrt{{{x}_{t} ( i )}^{T} {V}_{t - 1}^{- 1} {x}_{t} ( i )} for all i ∈ [ N ] \qquad ( 8 )$$

In expression (5), expression (6), and expression (8), τ

is a sign representing transposition.

### (Step S107)

In step S107, the selection section 12 selects options Iₜ such that a predicted value(s) of a reward(s) satisfies/satisfy a constraint condition determined in accordance with the baseline option(s) Iₜ^{b}, the predicted value(s) being obtained with reference to the data which has been accumulated by the accumulation section 13. In other words, the selection section 12 selects options Iₜ in each round t such that a predicted value(s) of a reward(s) satisfies/satisfy a constraint condition. For example, the constraint condition is expressed by expression (1) above. In a case where the parameter α=0.5 in expression (1), selecting options Iₜ in accordance with a constraint expressed by expression (1) ensures a performance that is 0.5 times a performance obtained in a case of selecting the baseline option(s) Iₜ^{b}. In expression (1), an expected value E[rₜ(i)] is expressed, for example, by

$$E [ {r}_{t} ( i ) ] = {θ}^{T} {x}_{t} ( i )$$

with use of a matrix θ R^{d} expressing linear contribution of options to rewards.

More specifically, the constraint condition is, for example, expressed for each round with use of at least (i) a sum, in each round, of an upper confidence bound(s) of a reward(s) obtained by the baseline option(s) Iₜ^{b} and (ii) a sum, in each round, of a lower confidence bound(s) of a reward(s) obtained by at least part of a set I of options that are candidates for options Iₜ to be selected by the selection section 12. In this case, the constraint condition is expressed, for example, by expression (2) above.

Further, the selection section 12 can also select options Iₜ such that a predicted value(s) of a reward(s) is/are increased under the constraint condition. In this case, the selection section 12 selects options Iₜ such that a sum

$$\sum \text{?} {r}_{t} ( i )$$

$$\text{?} \text{indicates text missing or illegible when filed}$$

of predicted values rₜ(i) of rewards for options i Iₜ in a round t is maximized. The function by which the sum of predicted values rₜ(i) of rewards is calculated is an example of an objective function in accordance with the present example embodiment.

More specifically, in a case where the constraint condition is expressed by expression (2) above, the selection section 12, as an example, selects options Iₜ by expression (9) below.

$${I}_{t} ∈ argmax \text{?} \sum \text{?} {{\hat{r}}^{\\}}_{t} ( i ) subject to \sum \text{?} {\hat{r}}_{t} ( i ) + \sum \text{?} ( α {\hat{r}}_{t} ( i ) + ( 1 - α ) {\hat{r}}_{t} ( i ) ) \geq ( 1 - α ) \sum \text{?} {\hat{r}}_{t} ( i ) \qquad ( 9 )$$

$$\text{?} \text{indicates text missing or illegible when filed}$$

### (Step S108)

In step S108, the selection section 12 provides the selected options Iₜ to the terminal apparatus 2A by transmitting the selected options Iₜ to the terminal apparatus 2A via the communication section 19A.

The option acquisition section 21 acquires the options Iₜ from the information processing apparatus 1A. The action execution section 23A executes actions based on the options Iₜ which have been acquired by the option acquisition section 21. As an example, in a case where options which have been selected by the information processing apparatus 1 are a “product P1”, a “product P2”, and a “product P3”, the action execution section 23A displays, on the display section 24A, information recommending the “product P1”, the “product P2”, and the “product P3” on a web page. Further, the reward information provision section 22 provides reward information to the information processing apparatus 1A by transmitting the reward information to the information processing apparatus 1A via the communication section 29A, the reward information being indicative of observed values of rewards obtained by the actions of the action execution section 23A.

### (Step S109)

In step S109, the acquisition section 11 acquires, via the communication section 19A, the observed values of rewards which are the reward information provided by the terminal apparatus 2A. Further, the acquisition section 11 updates the matrix Vt and the vector bt by the expression below.

$$\begin{matrix}{V}_{t} ← {V}_{t - 1} + \sum \text{?} {x}_{t} ( i ) {{x}_{t} ( i )}^{r} \\ {b}_{t} ← {b}_{t - 1} + \sum \text{?} {r}_{t} ( i ) {x}_{t} ( i )\end{matrix}$$

$$\text{?} \text{indicates text missing or illegible when filed}$$

### (Step S110)

In step S110, the accumulation section 13 accumulates, in the storage section 17A, data including: the options Iₜ which have been selected by the selection section 12; and observed values of rewards obtained by the options Iₜ.

### (Step S111)

Step S111 is an end of the loop process which is related to the round.

### <Example of Display by Information Processing System>

In the present example embodiment, the information processing system 100A can output information including options It which have been selected by the selection section 12 to an output apparatus such as the display section 24A of the terminal apparatus 2A.

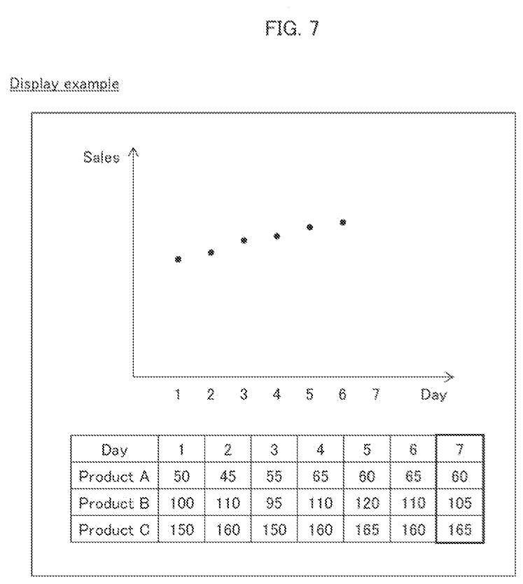

FIG. 7 is a diagram illustrating an example of display by the information processing system 100A. The example illustrated in FIG. 7 is a display example in a case where: (a sum of) sales of a plurality of products are (is) used as predicted values (a predicted value) of rewards; and one round is set to be one day. That is, in the example illustrated in FIG. 7, the selection section 12 of the information processing apparatus 1B selects options Iₜ on a day (round t) such that a constraint condition determined in accordance with a baseline option(s) Iₜ^{b} is satisfied.

Then, as illustrated in FIG. 7, the display section 24A of the terminal apparatus 2A displays observed values (in FIG. 7, sales) of rewards for each round (in FIG. 7, day). Further, in the example illustrated in FIG. 7, the display section 24A of the terminal apparatus 2A displays information (prices of products A to C) pertaining to the options selected in the round t.

By carrying out such display, the information processing system 100A can present, to a user, sales (observed values of rewards) and prices of products (options Iₜ).

### <Application Example of Information Processing System>

### (Web Marketing)

The following description will discuss an example in which the information processing system 1001A in accordance with the present example embodiment is applied to an advertisement action (marketing measure) of an operating company of a certain electronic commerce site. In this case, advertisement (online (banner) advertisement, email advertisement, direct mail, transmission of an email containing a discount coupon, or the like) targeting a plurality of customers with respect to an item such as a product or a service to be sold by the operating company is referred to as an action measure X (option I). In other words, in the present application example, selectable options include an advertisement for the item. For example, in a case where the action measure X=[1, 0, 2, . . . ], a first element indicates a banner advertisement to a customer A, a second element indicates no advertisement to a customer B, and a third element indicates transmission of an email containing a discount coupon to a customer C. An objective function receives input of the action measure X and outputs a result (a predicted value of a reward) obtained by applying the action measure X to an advertisement action targeting each customer. A reward includes at least one selected from the group consisting of: information pertaining to whether or not an advertisement has been selected on a web page (e.g. whether or not a banner advertisement has been clicked on); sales of the item; an expected value of sales; and a purchase probability.

In this application example, by applying the information processing method in accordance with the present example embodiment, it is possible to derive an advertisement action suitable for each customer of the operating company.

### (Dynamic Pricing)

The following description will discuss an example in which the information processing system 1001A in accordance with the present example embodiment is applied to determination of a price of a product. In this case, a discount in a beer price of each company at a store is referred to as an action measure (option). For example, in a case where an action measure X=[0, 2, 1, . . . ], a first element indicates setting of a beer price of a company A to a fixed price, a second element indicates a 10% increase in a beer price of a company B from a fixed price, and a third element indicates a 10% discount in a beer price of a company C from a fixed price. An objective function receives input of the execution measure X and outputs a result (a predicted value of a reward) obtained by applying the execution measure X to the beer price of each company every month and selling the beer. In other words, in the present application example, selectable options include a price setting of an item, and rewards include information indicative of a sales result of the item. The sales result includes at least one selected from the group consisting of: sales of the product; an expected value of sales; and a purchase probability.

In this case, by applying the information processing method in accordance with the present example embodiment, it is possible to derive a price setting suitable for a beer price of each company at the store.

### (Investment Portfolio)

The following description will discuss an example in which the information processing system 100A in accordance with the present example embodiment is applied to an investment action of an investor. In this case, investment (purchase, capital increase) with respect to a plurality of financial products (stock brands, etc.) held or to be held by the investor, or selling or holding of the plurality of financial products is referred to as an action measure X (option I). For example, in a case where the action measure X=[1, 0, 2, . . . ], a first element indicates an additional investment in stocks of a company A, a second element indicates holding (neither purchasing nor selling) receivables of a company B, and a third element indicates selling stocks of a company C. An objective function receives input of the execution measure X (option) and outputs a result (a predicted value of a reward) obtained by applying the execution measure X to an action with respect to each financial product. In this case, the predicted value of a reward, for example, is an expected value of a market value of the financial product. In other words, in the present application example, selectable options include an investment action with respect to a financial product, and rewards include information indicative of a market value of the financial product.

In this case, by applying the information processing method in accordance with the present example embodiment, it is possible to derive an investment action suitable to be taken by the investor with respect to each financial product.

### (Clinical Trial)

The following description will discuss an example in which the information processing system 1001A in accordance with the present example embodiment is applied to an administration action for a clinical trial of a certain drug of a pharmaceutical company. In this case, doses of administration to a plurality of subjects and the presence or absence of administration thereto are referred to as an execution measure X (option I). For example, in a case where the action measure X=[1, 0, 2, . . . ], a first element indicates carrying out administration in a dose 1 to a subject A, a second element indicates not carrying out administration with respect to a subject B, and a third element indicates carrying out administration in a dose 2 with respect to a subject C. An objective function receives input of the action measure X (option) and outputs a result (a predicted value of a reward) obtained by applying the execution measure X to an administration action to each subject. The predicted value of a reward, for example, is information pertaining to occurrence of a side effect (e.g. side effect occurrence rate). In this case, by applying the information processing method in accordance with the present example embodiment, it is possible to derive an administration action that reduces the side effect occurrence rate.

### Effects of Second Example Embodiment

As described above, the information processing apparatus 1A in accordance with the present example embodiment selects options Iₜ in a round t such that a constraint condition determined in accordance with a baseline option(s) Iₜ^{b} is satisfied. The baseline option(s) Iₜ^{b} is/are a set of options that can change from round t to round t. In the present example embodiment, in selection of the options Iₜ, a sum of observed values of rewards in the preceding rounds (rounds 1 to t) is not referred to. Thus, according to the present example embodiment, by selecting, in each round t, options Iₜ on the basis of a constraint condition determined in accordance with a baseline option(s) Iₜ^{b}, it is possible to ensure a certain level of reward in each round t even in a situation where selectable options can change from round t to round t.

Further, according to the present example embodiment, it is not necessary, in selection of options Iₜ, to refer to observed values of rewards in past rounds. This makes it possible to reduce a retrieval space for selecting the options Iₜ and improve computation efficiency.

Further, the information processing apparatus 1A in accordance with the present example embodiment selects options Iₜ such that a predicted value(s) of a reward(s) is/are increased, under a constraint condition determined in accordance with baseline options Iₜ^{b}. As such, according to the information processing apparatus 1A in accordance with the present example embodiment, it is possible to prevent rewards in each round t from becoming excessively low and increase the rewards obtained, in a situation where selectable options can change every round t.

Further, the selection section 12 of the information processing apparatus 1A in accordance with the present example embodiment includes the baseline selection section 14A which selects a baseline option(s) Iₜ^{b} from a set {xₜ(i)} and a reward prediction section 15A which calculates a predicted value(s) of a reward(s) with reference to data which has been accumulated by the accumulation section 13. Since the information processing apparatus 1A selects options on the basis of a constraint condition determined in accordance with a baseline option(s) which have been selected, it is possible to prevent rewards that are obtained from becoming excessively low.

Further, the information processing apparatus 1A in accordance with the present example embodiment acquires, in each round, information indicative of a set of selectable options and selects, in each round, options Iₜ such that a predicted value(s) of a reward(s) satisfies/satisfy a constraint condition. By acquiring a set of selectable options in each round, it is possible to prevent rewards that are obtained in each of the plurality of rounds from becoming excessively low.

Further, in the present example embodiment, use is made of a constraint condition expressed for each round with use of at least: a sum, in each round, of upper confidence bounds of rewards obtained by baseline options Iₜ^{b}; and a sum, in each round, of a lower confidence bound(s) of a reward(s) obtained by at least part of a set I of options. This makes it possible to prevent rewards that are obtained in each of a plurality of rounds from becoming excessively low.

### Third Example Embodiment

A third example embodiment of the present invention will be described in detail with reference to the drawings. Note that any constituent element that is identical in function to a constituent element described in the first example embodiment will be given the same reference numeral, and a description thereof will not be repeated.

### <Configuration of Information Processing Apparatus 1B>

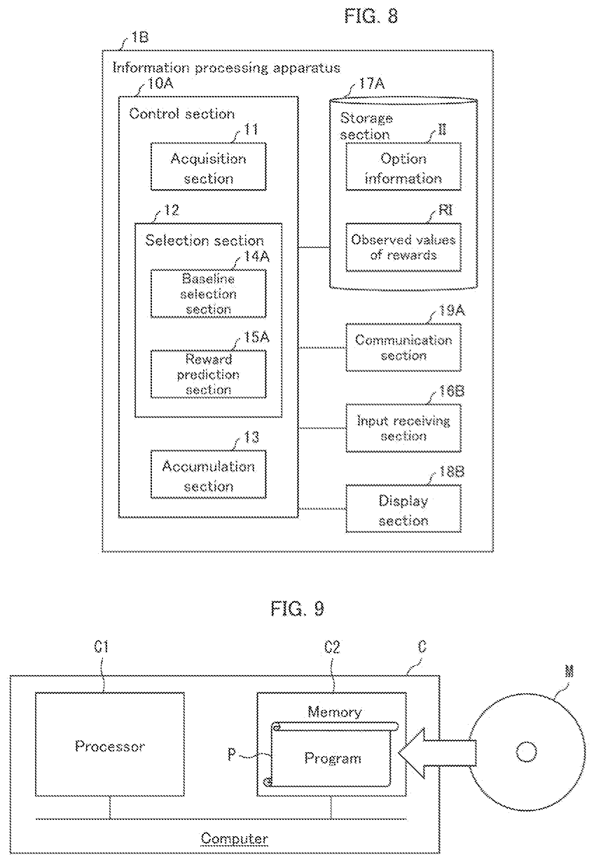

A configuration of an information processing apparatus 1B in accordance with the present example embodiment will be described with reference to FIG. 8. FIG. 8 is a block diagram illustrating the configuration of the information processing apparatus 1B.

As illustrated in FIG. 8, the information processing apparatus 1B includes, in addition to the components included in the information processing apparatus 1A in accordance with the example embodiment, a display section 18B and an input receiving section 16B. The display section 18B is configured to be capable of displaying various data to be processed by the information processing apparatus 1B. The content displayed by the display section 18B is controlled by a control section 10A. As an example, the display section 18B includes a display panel and a drive circuit for driving the display panel.

The input receiving section 16B receives various inputs to the information processing apparatus 1B. A specific configuration of the input receiving section 16B is not intended to limit the present example embodiment. As an example, the input receiving section 16B includes an input device such as a keyboard and a touchpad. In addition, the input receiving section 16B may include, for example, a data scanner for reading data via electromagnetic waves, such as infrared rays and radio waves. The input receiving section 16B acquires the above-described observed value of a reward via, for example, the input device, the data scanner, and the like, which are described above, and supplies the acquired pieces of information to the control section 10A.

In the second example embodiment described above, the selection section 12 of the information processing apparatus 10A provides options Iₜ which have been selected to the terminal apparatus 2A by transmitting the options Iₜ to the terminal apparatus 2A (step S108 in FIG. 6). In contrast, in the present example embodiment, a selection section 12 of the information processing apparatus 1B outputs information including options Iₜ which have been selected to an output apparatus such as the display section 18B. For example, the selection section 12 displays, on the display section 18B, the example screen illustrated in FIG. 7 above. Further, as an example, the selection section 12 can execute actions based on the options Iₜ which have been selected.

Further, in the second example embodiment described above, the acquisition section 11 of the information processing apparatus 12A acquires observed values of rewards by receiving the observed values from the terminal apparatus 2A (step S109 in FIG. 6). In contrast, in the present example embodiment, an acquisition section 11 of the information processing apparatus 10B, as an example, acquires observed values of rewards which observed values have been received by the input receiving section 16B. Further, as an example, the acquisition section 11 can acquire observed values of rewards which observed values are received via a communication section 19A.

Also in the present example embodiment, the information processing apparatus 1B carries out display as illustrated in FIG. 7 as in the above-described second example embodiment, so that sales (observed values of rewards) and prices of products (options Iₜ) can be presented to a user.

### [Software Implementation Example]

Some or all of functions of the information processing apparatuses 1, 1A, and 1B can be realized by hardware such as an integrated circuit (IC chip) or can be alternatively realized by software.

In the latter case, the information processing apparatuses 1, 1A, and 1B are each realized by, for example, a computer that executes instructions of a program that is software realizing the foregoing functions. FIG. 9 illustrates an example of such a computer (hereinafter referred to as “computer C”). The computer C includes at least one processor C1 and at least one memory C2. The at least one memory C2 stores a program P for causing the computer C to operate as each of the information processing apparatuses 1, 1A, and 1B. In the computer C, the at least one processor C1 reads and executes the program P stored in the at least one memory C2, so that the functions of the information processing apparatuses 1, 1A, and 1B are realized.

Examples of the at least one processor C1 encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the at least one memory C2 encompass a flash memory, a hard disk drive (HDD), a solid state drive (SSD), and a combination thereof.

Note that the computer C may further include a random access memory (RAM) in which the program P is loaded when executed and/or in which various data are temporarily stored. Moreover, the computer C may further include a communication interface for transmitting/receiving data to/from another apparatus. The computer C may further include an input/output interface for connecting the computer C to an input/output apparatus(es) such as a keyboard, a mouse, a display, and/or a printer.

The program P can be stored in a non-transitory tangible storage medium M which is readable by the computer C. Examples of the storage medium M encompass a tape, a disk, a card, a semiconductor memory, and a programmable logic circuit. The computer C can obtain the program P via such a storage medium M. Further, the program P can be transmitted via a transmission medium. Examples of the transmission medium encompass a communication network and a broadcast wave. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following example aspects.

### (Supplementary Note 1)

An information processing apparatus, including:
an acquisition means for acquiring information indicative of a set of options that are selectable in a round;
a selection means for selecting a plurality of options from the set; and
an accumulation means for accumulating data that includes (i) the plurality of options which have been selected by the selection means and (ii) observed values of rewards obtained by the plurality of options which have been selected by the selection means,
the selection means selecting the plurality of options such that a predicted value of a reward satisfies a constraint condition determined in accordance with a baseline option selected from the set, the predicted value being obtained with reference to the data which has been accumulated by the accumulation means.

The above-described configuration makes it possible to prevent rewards that are obtained from becoming excessively low in a situation where selectable options can change every round.

### (Supplementary Note 2)

The information processing apparatus according to supplementary note 1, wherein the selection means selects the plurality of options such that the predicted value of a reward is increased under the constraint condition.

The above-described configuration makes it possible to prevent rewards in each round from becoming excessively low and increase the rewards obtained, in a situation where selectable options can change every round.

### (Supplementary Note 3)

The information processing apparatus according to supplementary note 1 or 2, wherein the selection means includes:
a baseline selection means for selecting the baseline option from the set; and
a reward prediction means for calculating the predicted value of a reward with reference to the data which has been accumulated by the accumulation means.

According to the above configuration, options are selected on the basis of a constraint condition determined in accordance with a baseline option(s) which has/have been selected. This makes it possible to prevent rewards that are obtained from becoming excessively low.

### (Supplementary Note 4)

The information processing apparatus according to any one of supplementary note 1 to 3, wherein:
the acquisition means acquires, in each round, the information indicative of the set of options that are selectable; and
the selection means selects, in each round, the plurality of options such that the predicted value of a reward satisfies the constraint condition.

According to the above configuration, a set of selectable options are acquired in each round. This makes it possible to prevent rewards that are obtained in each of the plurality of rounds from becoming excessively low.

### (Supplementary Note 5)

The information processing apparatus according to supplementary note 4, wherein the constraint condition is expressed for each round with use of at least:
a sum, in each round, of an upper confidence bound of a reward obtained by the baseline option; and
a sum, in each round, of a lower confidence bound of a reward obtained by at least part of candidates for the plurality of options selected by the selection means.

According to the above configuration, use is made of a constraint condition expressed for each round with use of at least: a sum, in each round, of an upper confidence bound(s) of a reward(s) obtained by a baseline option(s); and a sum, in each round, of a lower confidence bound(s) of a reward(s) obtained by at least part of candidates for a plurality of options to be selected by the selection means. This makes it possible to prevent rewards that are obtained in each of a plurality of rounds from becoming excessively low.

### (Supplementary Note 6)

The information processing apparatus according to any one of supplementary note 1 to 5, further including an input device for receiving the observed values of rewards.

According to the above configuration, options are selected such that a predicted value(s) of a reward(s) satisfies a constraint condition, the predicted value(s) being obtained with reference to observed values of rewards received by the input device. This makes it possible to prevent rewards that are obtained from becoming excessively low in a situation where selectable options can change every round.

### (Supplementary Note 7)

An information processing method, including, in a repeated manner, the steps of:
an information processing apparatus acquiring information indicative of a set of options that are selectable in a round;
the information processing apparatus selecting a plurality of options from the set; and
the information processing apparatus accumulating data that includes (i) the plurality of options which have been selected in the step of selecting the plurality of options and (ii) observed values of rewards obtained by the plurality of options which have been selected in the step of selecting the plurality of options,
wherein, in the step of selecting the plurality of options, the plurality of options are selected such that a predicted value of a reward satisfies a constraint condition determined in accordance with a baseline option selected from the set, the predicted value being obtained with reference to the data which has been accumulated.

The above-described method brings about an effect that is similar to the effect brought about by the information processing apparatus described above.

### (Supplementary Note 8)

A program causing a computer to function as an information processing apparatus, wherein
the program causes the computer to function as:
an acquisition means for acquiring information indicative of a set of options that are selectable in a round;
a selection means for selecting a plurality of options from the set; and
an accumulation means for accumulating data that includes (i) the plurality of options which have been selected by the selection means and (ii) observed values of rewards obtained by the plurality of options which have been selected by the selection means,
the selection means selecting the plurality of options such that a predicted value of a reward satisfies a constraint condition determined in accordance with a baseline option selected from the set, the predicted value being obtained with reference to the data which has been accumulated by the accumulation means.

The above-described program brings about an effect that is similar to the effect brought about by the information processing apparatus described above.

### (Supplementary Note 9)

An information processing system, comprising an information processing apparatus and a terminal apparatus, wherein
the information processing apparatus includes:
   an acquisition means for acquiring information indicative of a set of options that are selectable in a round;
   a selection means for selecting a plurality of options from the set; and
   an accumulation means for accumulating data that includes (i) the plurality of options which have been selected by the selection means and (ii) observed values of rewards obtained by the plurality of options which have been selected by the selection means,
   the selection means selecting the plurality of options such that a predicted value of a reward satisfies a constraint condition determined in accordance with a baseline option selected from the set, the predicted value being obtained with reference to the data which has been accumulated by the accumulation means, and
the terminal apparatus includes:
   an option acquisition means for acquiring the plurality of options which have been selected by the selection means; and
   a reward information provision means for providing, to the information processing apparatus, reward information indicative of rewards obtained by executing actions indicated by the plurality of options.

The above-described information processing system brings about an effect that is similar to the effect brought about by the information processing apparatus described above.

### (Supplementary Note 10)

An information processing method, including, in a repeated manner, the steps of:
an information processing apparatus acquiring information indicative of a set of options that are selectable in a round;
the information processing apparatus selecting a plurality of options from the set; and
the information processing apparatus accumulating data that includes (i) the plurality of options which have been selected in the step of selecting the plurality of options and (ii) observed values of rewards obtained by the plurality of options which have been selected in the step of selecting the plurality of options,
wherein, in the step of selecting the plurality of options, the plurality of options are selected such that a predicted value of a reward is increased under a constraint condition determined in accordance with a baseline option selected from the set, the predicted value being obtained with reference to the data which has been accumulated,
the information processing method further including the steps of:
   a terminal apparatus acquiring the plurality of options which have been selected in the step of selecting the plurality of options; and
   the terminal apparatus providing, to the information processing apparatus, reward information indicative of rewards obtained by executing actions indicated by the plurality of options.

The above-described information processing method brings about an effect that is similar to the effect brought about by the information processing apparatus described above.

### (Supplementary Note 11)

The information processing apparatus according to any one of supplementary notes 1 to 6, wherein:
the options that are selectable include an advertisement for an item; and
the rewards include at least one selected from the group consisting of: information pertaining to whether or not an advertisement has been selected on a web page; sales of the item; an expected value of sales; and a purchase probability.

### (Supplementary Note 12)

The information processing apparatus according to any one of supplementary notes 1 to 6, or 11, wherein:
the options that are selectable include a price setting of the item; and
the rewards include information indicative of a sales result of the item.

### (Supplementary Note 13)

The information processing apparatus according to any one of supplementary notes 1 to 6, or 11 to 12, wherein:
the options that are selectable include an investment action with respect to a financial product; and
the rewards include information indicative of a market value of the financial product.

### (Supplementary Note 14)

The information processing apparatus according to any one of supplementary notes 1 to 6, or 11 to 13, wherein:
the options that are selectable include administration with respect to a subject; and
the rewards include information pertaining to occurrence of a side effect.

### [Additional Remark 3]

Furthermore, some of or all of the foregoing example embodiments can also be described as below.

An information processing apparatus including at least one processor, the at least one processor carrying out: an acquisition process of acquiring information indicative of a set of options that are selectable in a round; a selection process of selecting a plurality of options from the set; and an accumulation process of accumulating data that includes (i) the plurality of options which have been selected in the selection process and (ii) observed values of rewards obtained by the plurality of options which have been selected in the selection process, wherein, in the selection step, the plurality of options are selected such that a predicted value of a reward satisfies a constraint condition determined in accordance with a baseline option selected from the set, the predicted value being obtained with reference to the data accumulated in the accumulation process.

Note that the information processing apparatus can further include a memory. The memory can store a program for causing the processor to execute the acquisition process, the selection process, and the accumulation process. The program can be stored in a computer-readable non-transitory tangible storage medium.

### REFERENCE SIGNS LIST

1, 1A, 1B: information processing apparatus
11: acquisition section
12: selection section
13: accumulation section
14A: baseline selection section
15A: reward prediction section
16B: input receiving section
17A: storage section
18B: display section
2, 2A: terminal apparatus
21: option acquisition section
22: reward information provision section
23A: action execution section
100, 100A: information processing system

What is claimed is:

1. An information processing apparatus, comprising at least one processor, the at least one processor carrying out:
an acquisition process of acquiring information indicative of a set of options that are selectable in a round;
a selection process of selecting a plurality of options from the set; and
an accumulation process of accumulating data that includes (i) the plurality of options which have been selected in the selection process and (ii) observed values of rewards obtained by the plurality of options which have been selected in the selection process,
in the selection process, the at least one processor selecting the plurality of options such that a predicted value of a reward satisfies a constraint condition determined in accordance with a baseline option selected from the set, the predicted value being obtained with reference to the data which has been accumulated in the accumulation process.

2. The information processing apparatus according to claim 1, wherein in the selection process, the at least one processor selects the plurality of options such that the predicted value of a reward is increased under the constraint condition.

3. The information processing apparatus according to claim 1, wherein in the selection process, the at least one processor carries out:
a baseline selection process of selecting the baseline option from the set; and
a reward prediction process of calculating the predicted value of a reward with reference to the data which has been accumulated in the accumulation process.

4. The information processing apparatus according to claim 1, wherein:
in the acquisition process, the at least one processor acquires, in each round, the information indicative of the set of options that are selectable; and
in the selection process, the at least one processor selects, in each round, the plurality of options such that the predicted value of a reward satisfies the constraint condition.

5. The information processing apparatus according to claim 4, wherein the constraint condition is expressed for each round with use of at least:
a sum, in each round, of an upper confidence bound of a reward obtained by the baseline option; and
a sum, in each round, of a lower confidence bound of a reward obtained by at least part of candidates for the plurality of options selected by the at least one processor in the selection process.

6. The information processing apparatus according to claim 1, further comprising an input device for receiving the observed values of rewards.

7. An information processing method, comprising, in a repeated manner, the steps of:
an information processing apparatus acquiring information indicative of a set of options that are selectable in a round;
the information processing apparatus selecting a plurality of options from the set; and
the information processing apparatus accumulating data that includes (i) the plurality of options which have been selected in the step of selecting the plurality of options and (ii) observed values of rewards obtained by the plurality of options which have been selected in the step of selecting the plurality of options,
wherein, in the step of selecting the plurality of options, the plurality of options are selected such that a predicted value of a reward satisfies a constraint condition determined in accordance with a baseline option selected from the set, the predicted value being obtained with reference to the data which has been accumulated.

8. A computer-readable non-transitory storage medium storing therein a program for causing a computer to function as an information processing apparatus recited in claim 1,
the program causing the computer to carry out the acquisition process, the selection process, and the accumulation process.

9. An information processing system, comprising an information processing apparatus recited in claim 1 and a terminal apparatus, wherein
the terminal apparatus includes at least one processor, the at least one processor of the terminal apparatus carrying out:
an option acquisition process of acquiring the plurality of options which have been selected in the selection process; and
a reward information provision process of providing, to the information processing apparatus, reward information indicative of rewards obtained by executing actions indicated by the plurality of options.

10. An information processing method, comprising, in a repeated manner, the steps of:
an information processing apparatus acquiring information indicative of a set of options that are selectable in a round;
the information processing apparatus selecting a plurality of options from the set; and
the information processing apparatus accumulating data that includes (i) the plurality of options which have been selected in the step of selecting the plurality of options and (ii) observed values of rewards obtained by the plurality of options which have been selected in the step of selecting the plurality of options,
wherein, in the step of selecting the plurality of options, the plurality of options are selected such that a predicted value of a reward is increased under a constraint condition determined in accordance with a baseline option selected from the set, the predicted value being obtained with reference to the data which has been accumulated,
the information processing method further comprising the steps of:
a terminal apparatus acquiring the plurality of options which have been selected in the step of selecting the plurality of options; and
the terminal apparatus providing, to the information processing apparatus, reward information indicative of rewards obtained by executing actions indicated by the plurality of options.
